(19) United States
(12) Patent Application Publication
(10) Pub. No.: US 2007/0073756 A1
(43) Pub. Date: Mar. 29, 2007

(54) System and method configuring contextual based content with published content for display on a user interface

(76) Inventors: Jivan Manhas, Toronto (CA); Peter Bordes, New York, NY (US); Joseph Matheny, Santa Barbara, CA (US)

Correspondence Address: Ralph A. Dowell of DOWELL & DOWELL P.C., 2111 Eisenhower Ave, Suite 406, Alexandria, VA, 22314, US

(21) Appl. No.: 11/516,586

(22) Filed: Sep. 7, 2006

Related U.S. Application Data
(60) Provisional application No. 60/720,549, filed on Sep. 26, 2005.

(51) Int. Cl. G06F 7/00

(52) U.S. Cl. 707/101

(57) ABSTRACT

A system and method for generating secondary advertising content for presentation on a user interface of a device in association with primary publishing content. The system and method comprise a queue for receiving the primary content including a plurality of identifiable textual elements for analysis as candidates to associate with the secondary content. The plurality of identifiable textual elements are distributed in a number of defined regions of the primary content such as paragraphs. The system and method also have a content analyzer module configured for accessing the primary content and for performing a contextual analysis of the plurality of identifiable textual elements. The analysis includes determining for each of the number of defined regions those key elements from the identifiable textual elements that match element entries in at least one key element list. The analysis further includes determining a density of the matched key elements from a specified region of the number of defined regions. The system and method further include a threshold module for determining if the density exceeds a predefined density threshold for a category including a predefined list of category elements, where at least some of matched key elements being included in the list of category elements. The category is linked to the secondary content. The system and method further include an instruction module configured for generating an association instruction for linking the secondary content to at least one of the matched key elements associated with the category. The secondary content is made available to the device for presentation on the user interface in relation to the primary content through use of the association instruction.

This application claims the benefit of U.S. Provisional Application No. 60/720,549, filed Sep. 26, 2005, in its entirety herein incorporated by reference.

This invention relates generally to the placement of information on a user interface.

### BACKGROUND OF THE INVENTION

Placement of advertising and other secondary content, such as advertisements (ads), on user interface displays of published information (e.g. web pages) has grown in popularity due to advantages in revenue generation. Research has shown ads that are contextual to information read by a user group yield a higher response ratio, and in return that user group yields a higher ratio of qualified leads for additional product sale opportunities. Current ad selection and placement methodologies include assigning ads based on search terms used to access the published information, as well as general areas for placement of the ads with respect to the published information. An example of current ad selection and placement methodologies is Goggle, which provides published information in response to a search term and also includes ads that are assigned to that search. Example placement of the ads include banner ads positioned on the same location of a webpage, regardless of information details in the published information, including the search term used to access the information.

One problem associated with current ad selection and placement methodologies is that the ad may not be positioned near enough to that part of the published information that is of interest to the reader of the published information. A further problem is that the ad may not be appropriate for the context of the published information. For example, the user may desire published information on old cars for determining a suitable location for repair, however the car ads displayed with the published information may be directed to purchase of luxury automobiles. A further problem with current ad selection and placement methodologies is that typical ads take the user off the published information content pages in order to respond to the ad. A further problem with current ad selection and placement methodologies is that they only use inventory from one ad source. Another problem with current ad selection and placement methodologies is that they use precious screen real estate to display the ads.

It is an object of the present invention to provide a contextual based analysis environment to obviate or mitigate at least some of the above presented disadvantages.

### SUMMARY OF THE INVENTION

Contrary to the state of the art advertising methodologies, there is provided a system and method for generating secondary advertising content for presentation on a user interface of a device in association with primary publishing content. The system and method comprise a queue for receiving the primary content including a plurality of identifiable textual elements for analysis as candidates to associate with the secondary content. The plurality of identifiable textual elements are distributed in a number of defined regions of the primary content such as paragraphs. The system and method also have a content analyzer module configured for accessing the primary content and for performing a contextual analysis of the plurality of identifiable textual elements. The analysis includes determining for each of the number of defined regions those key elements from the identifiable textual elements that match element entries in at least one key element list. The analysis further includes determining a density of the matched key elements from a specified region of the number of defined regions. The system and method further include a threshold module for determining if the density exceeds a predefined density threshold for a category including a predefined list of category elements, where at least some of matched key elements being included in the list of category elements. The category is linked to the secondary content. The system and method further include an instruction module configured for generating an association instruction for linking the secondary content to at least one of the matched key elements associated with the category. The secondary content is made available to the device for presentation on the user interface in relation to the primary content through use of the association instruction.

A first aspect provided is a system for assigning secondary content for presentation on a user interface of a device in association with primary content, the system comprising: a storage for receiving the primary content including a plurality of identifiable elements for analysis as candidates for at least one key element to associate with the secondary content, the plurality of identifiable elements distributed in a number of defined regions of the primary content; a content analyzer module configured for accessing the primary content and for performing a contextual analysis of the plurality of identifiable elements, the analysis including for each of the number of defined regions determining in the plurality of identifiable elements those key elements matching an element entry in at least one key element list, the analysis further including determining a density of the matched key elements from a specified region of the number of defined regions; a threshold module for determining the density exceeds a predefined density threshold for a category including a predefined list of category elements, at least some of matched key elements being included in the list of category elements, the category linked to the secondary content; and an instruction module configured for generating an association instruction for linking the secondary content to at least one of the matched key elements associated with the category; wherein the secondary content is made available to the device for presentation on the user interface in relation to the primary content through use of the association instruction.

A second aspect provided is a method for assigning secondary content for presentation on a user interface of a device in association with primary content, the method comprising the steps of: receiving the primary content including a plurality of identifiable elements for analysis as candidates for at least one key element to associate with the secondary content, the plurality of identifiable elements distributed in a number of defined regions of the primary content; accessing the primary content and for performing a contextual analysis of the plurality of identifiable elements, the analysis including for each of the number of defined regions determining in the plurality of identifiable elements those said key elements matching element entries in at least one key element list; determining a density of the matched key elements from a specified region of the number of defined regions; determining the density exceeds a predefined density threshold for a category including a predefined list of category elements, at least some of matched key elements being included in the list of category elements, the category linked to the secondary content; and generating an association instruction for linking the secondary content to at least one of the matched key elements associated with the category; wherein the secondary content is made available to the device for presentation on the user interface in relation to the primary content through use of the association instruction.

A further aspect provided is a information server configured for interaction with a device requesting primary content and configured for coordinating the sending of secondary content associated with the primary content to the requesting device, such that the secondary content is matched to selected content portions of the primary content.

A further aspect provided is an electronic data transmission/signal configured for transmission over a network and including modified primary content and a series of association instructions linking secondary content to selected portions of the primary content.

### BRIEF DESCRIPTION OF THE DRAWINGS

These and other features of the preferred embodiments of the invention will become more apparent in the following detailed description in which reference is made to the appended drawings wherein:

FIG. 1 is a block diagram of a network system;

FIG. 2 is a block diagram of a device of FIG. 1;

FIG. 3 is a block diagram of a file of FIG. 1;

FIG. 4 is a block diagram of a content analysis environment of FIG. 1;

FIG. 5 is a block diagram of association rules of FIG. 1;

FIG. 6 is an example interface of the system of FIG. 1;

FIG. 7 is an example list of categories of the system of FIG. 1;

FIG. 8 is shows example contents of one of the categories of FIG. 7;

FIG. 9 is a further example of the interface of FIG. 1;

FIG. 10 is a flowchart illustrating operation of the network system of FIG. 4; and

FIG. 11 is a further flowchart illustrating operation of the network system of FIG. 4.

### DESCRIPTION OF THE PREFERRED EMBODIMENTS

Network System 10

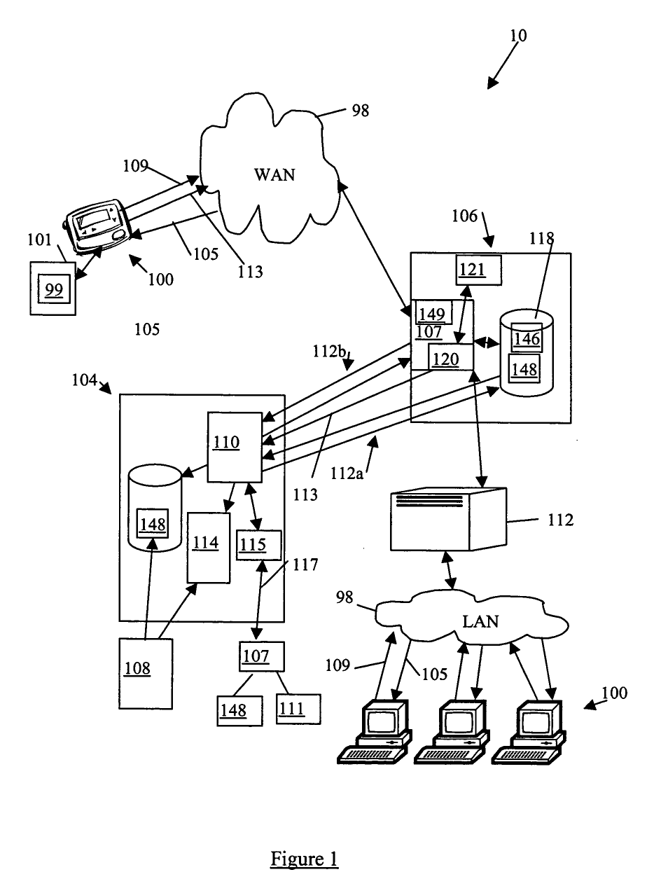

Referring to FIG. 1, a network system 10 comprises a plurality of networked computers 100, hereafter referred to as devices 100 for the sake of simplicity, for interacting with one or more generic schema defined services of information environments/source 106, hereafter referred to as publisher environments by example only, which are provided through information servers 107 (e.g. content servers). The schema defined services are provided as primary content 146 (including text and/or graphics information) accessible as pages/files, and/or contents of response messages, by the users of the devices 100 though information requests 109, via a coupled Wide Area Network (WAN) 98 (such as but not limited to the Internet). This content 146 represents a desired exchange of data between the devices 100 and the information environments 106, either synchronously or asynchronously as initiated by the device 100 or the information environment 104. The content 146 can include information requested by the user that is available over the network 98 as published material (e.g. web pages) and/or as information that is sent to the device 100 in response to a unit of work performed on behalf of the device 100 by some computing entity of the information environment 106 (e.g. facilitating transactions).

The content 146 can be sent to the device 100 as the pages/files and/or the contents of response messages, hereafter referred to as files 105 for convenience only, and are configured for display/presentation on a user interface 99 of the device 100 via a device application program 101, such as a browser. The device application program 101 is configured for accessing the services (e.g. functionality and/or content) of the information environments 106 and for displaying or otherwise presenting the services of the information environments 106 on the user interface 99 of the device 100, as the files 105 processed by a content analyzer environment 104, further described below, which can be considered as a source for the contextual based content 148. These devices 100 can be such as but not limited to personal computers, wireless devices, PDAs, self-service kiosks and the like. The content 146 provided by the information servers 107 can be Web Services and/or other services such as but not limited to SQL Databases, Legacy Databases, and J2EE as desired. Further, the network system 10 can also have a gateway server 112 for connecting the computer devices 100 via a Local Area Network (LAN) 98 to the information servers 107 of the information environments 106. Further, the network 98 can include a wireless network for connecting the wireless devices 100. It is recognized that other devices and computers (not shown) could be connected to the information servers 107 via the network 98 other than as shown in FIG. 1. Web services are selected for the following description of the system 10, for the sake of simplicity, however it is recognized that other generic schema defined services could be substituted for the Web services, if desired. Accordingly, it is recognized that the files 105 can represent content 146 requested 109 or otherwise delivered from the environment 106.

Referring again to FIG. 1, the system 10 also includes the content analyzer environment 104 for associating contextual based content 148 (e.g. supplied by third party content providers 108), also referred to as secondary content 148, to the primary content 146. The content analyzer environment 104 uses a page/file analyzer 110 to dynamically associate the contextual based content 148 to the content 146, upon request 112a,112b, according to a predefined set of association rules 114, further described below. One example of the association rules 114 is where a web service provider (e.g. environment 106) defines how advertisement information via pop-ups and/or banner ads (e.g. contextual based content 148) of third party service provider(s) 108 is to be displayed on the browser 101, in connection with specific words, text portions (paragraphs), images, and/or pages of the content 146. The association rules 114 can include the type/content of the advertisement information based on contextual analysis of the text and/or images of the publisher content 146, the display timing of the advertisement information (e.g. click-on , mouse-over events), and the positioning of the advertisement information with respect to the content 146 on the user interface 99. The file 105 is used to facilitate the making available of the advertisement information (an example of the contextual based content 148) to the browser 101 along with the text/images of the content 146, further described below.

File 105

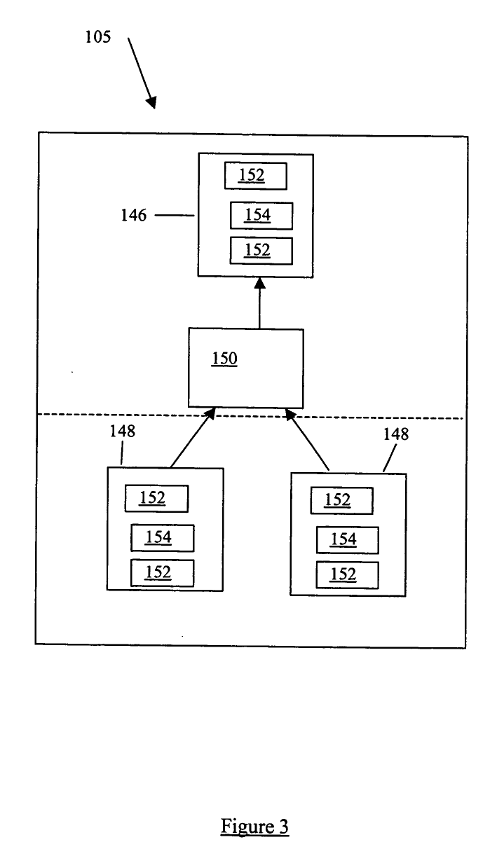

Referring to FIG. 3, the file 105 includes the content 146 provided by the information environment 106, the contextual based content 148 provided by the content analyzer environment 104 (either explicitly or implicitly through links), and association instructions 150 also provided by the content analyzer environment 104 for associating selected portions (e.g. key elements K1,K2,K3) of the primary content 146 with the contextual based content 148 (i.e. secondary content).

Content 146

The content 146 represents the information received by the device 100 from the information server 107 that is intended for display on the device 100. Examples of the content 146 can include text and/or images configured for display as a Web page (or series of Web pages) by the browser 101, such that the information environment 106 is a Web service. It is recognized that the content 146 includes a plurality of key elements K1,K2,K3 distributed within the broader context of a plurality of identifiable elements (e.g. text, images). The plurality of identifiable elements (e.g. text, images) in the content 146 is organized into a plurality of predefined regions, e.g. paragraphs, areas, pages, etc.

Another example of the content 146 is XML defined data generated in connection with a transaction proceeding between the information environment 106 and the device 100, such that the XML defined data is displayable or otherwise presentable by the application program 101 on the user interface 99 and is intended as the primary mechanism for the exchange of information related to the information request 109.

Contextual Based Content 148

The contextual based content 148 represents additional/secondary presentation content that is associated with the content 146 by the content analyzer environment 104. For example, the contextual based content 148 can be configured as a popup window in a web browser 101 window that is smaller than the standard windows and without some of the standard features such as tool bars, navigation bars, or status bars (not shown) of the browser 101. Popup windows (aka popups) can be used for smaller sidebar-style pages or overlay pages that are digressions from the main page (e.g. content 146). It is recognized that the contextual based content 148 can be interactive (requiring user action) with the user once displayed by the browser 101. Further, it is recognized that the contextual based content 148 can include flash video, text, and sound (e.g. music file), as desired

The contextual based content 148 is related to the content 146, through recognized key elements K1,K2,K3 (e.g. key words or phrases and/or images) contained in the content 146, as further described below. Examples of the contextual based content 148 configured for display on the device 100 can include content such as but not limited to: popup ads; banner ads; text link ads; flash ads; initiation of a transaction (sale of product); RSS feeds (describing news, discussion forum excerpts, software announcements, or other Web content, and any form of content retrievable with a URL that is available for “feeding” through distribution or syndication from an online publisher to Web users); podcasting (the preparation and distribution of audio files using RSS to the computers of subscribed users); hyperlinks; and/or a set of interactive forms. It is recognized, based on the above presented examples, that the contextual based content 148 can be static (i.e. for informational purposes only to the user of the device 100), dynamic (i.e. enables interaction with the information by the user through user events—e.g. clicking on navigational objects), or a combination thereof.

Examples of contextual based content 148 (e.g. ads) can include popup windows such as but not limited to: “sticky” pop-ups that hang around until they are actively closed or are replaced by another popup; tooltip pop-ups; full screen pop-ups; mouse-over pop-ups; and auto closing pop-ups. The contextual based content 148 can serve as informational and navigational aids for the content 146 of Websites accessed for example via the browser 101, for example. Links (e.g. association instructions 150) can invoke pop-ups with the distribution default styles or customized for the desired look and feel of the information environment 106. The pop-ups can toggle off mouse-following behavior (e.g. association instructions 150 such as hovering next to a displayed keyword) and impose an onset delay and a timeout, for example.

Association Instructions 150

The association instructions 150 provide for static and/or dynamic linking of the contextual based content 148 to the content 146 during display thereof. The association instructions 150 can be provided as a sequence of instructions (e.g. script) to facilitate display timing and/or placement of the contextual based content 148 with respect to the content 146 displayed in the browser 101 of the user device 100. The association instructions 150 facilitate embedding of the contextual based content 148 in the file 105 and displaying of the contextual based content 148 in the browser 101 of the user device 100. The display of the contextual based content 148 can be configured, for example: as a default when displaying the content 146 (e.g. banner ads placed adjacent to the Web page content of the environment 106); or for invocation in response to user actions (e.g. activated in the web browser 101 when the user moves a mouse over predefined words/images/phrases/positions in the content 146 and/or clicking on an identifiable link); or a combination thereof. The association instructions 150 also facilitate contextual based content 148 matching and rotation logic such that the users may see different contextual based content 148 on subsequent visits to the information environment 106 (e.g. revisiting of a particular page of a Web site) via the network 98. The association instructions 150 open or otherwise facilitate the display of the contextual based content 148, for example adjacent or on top of the content 146. Activation of the association instructions 150 (e.g. running of script) can be done by: running when the user clicks (on-click event) on a link or performs some other user action (e.g. mouse-over/hover event); any event supported by browsers 101 for invoking Javascript (e.g., onload); automatically configured as integral to the displaying of the content 146 in the browser 101; or a combination thereof.

One example of the association instructions 150 is using JavaScript defined pop-ups, which create fully-formatted pop-ups that can contain formatted text (bold, italic, different fonts etc.), graphics, hyperlinks (both topic and Internet links) and even video and animation files. In addition, JavaScript defined pop-ups can also support a range of graphical effects and transitions (fade-in, transparency, etc . . . ). An example of the file 105 and associated contents 146,148,150 is as follows. Ads (contextual based content 148) are delivered to web users (via user device 100) in the form of web-banners and activated (association instructions 150) in the web browser 101 when the user moves his mouse over the words/images (publisher content 146) on the displayed web page (file 105). Further, if user clicks on the ad, they can get redirected (association instructions 150) to the actual offer via the same window or via a new window, as desired.

Accordingly, in view of the above, the association instructions 150 can be, for example, a dynamic link that is associated with a selected keyword K1 identified on the user interface 99. In this respect, when the user does a mouse-over or otherwise clicks on the keyword K1, the respective dynamic link sends a content request message 113 (see FIG. 1) to the content analyzer environment 104 via the information environment 106 (or directly if desired) via the network 98. In response, a content analyzer environment 104 can coordinate transmission of the associated contextual based content 148 to be displayed with respect to the keyword K1 on the user interface 99, as further described below.

File 105 Format

The content of the file/document 105 (e.g. a web page or XML defined data) is formatted via a schema defined language, such as but not limited to HTML, XHTML, XML, or other languages derived from the Standard Generalized Markup Language (SGML), that is used as a standard or common way to create the file 105 structure. The content of the file 105 is processed by the respective computing environment (e.g. information. environment 106, content analyzer environment 104, and/or user device 100) having prior knowledge of the schema defined language used to define the file 105. It is recognized that the respective computing environments can switch between schema defined languages, as desired, e.g. the content analyzer environment 104 provides file content in XML which is then transformed into HTML by the information environment 106.

The file 105 contains the content 146 including data 154 (e.g. text, images, etc . . . ) and markup symbols or codes (e.g. metadata/tags) 152 that describe that data 154. For example, HTML markup symbols 152 define the data 154 of the file 105 (mainly text and graphic images) in terms of how the data 154 is to be displayed and interacted with via the web browser 101 running on the user device 100. Further, XML markup symbols 152 define the data 154 of the file 105 in terms of what data is being described, for example the word “personname” placed within the XML markup symbols 152 could indicate that the data 154 that followed was the name of a person. This means that the XML file 105 can be processed purely as data by a program (e.g. browser 101), the XML file 105 can be stored with similar data on another computer, or like an HTML file 105 can be displayed via the browser 101. In terms of the file 105 requested from the environment 106, the markup symbols 152 instruct the Web browser 101 how to display the words and images data 154 of the file 105 (e.g. a Web page) for interaction with the user of the device 100. It is understood that each individual markup symbol/code 152 can be referred to as an element/tag, wherein some elements come in pairs that indicate when some displayed effect data 154 via the browser 101 is to begin and when the displayed effect data 154 is to end. It is recognized that the file 105 also contains the association instructions 150 as a series of links, programs and/or sequence of instructions, e.g. written in script, used to define the processing of the data 154 and markup symbols 152 of the information content 146 for association with the contextual based content 148, as further described below. It is recognized that the contextual based content 148 and the content 146 are represented as data 154 and can be defined in the file 105 using the markup symbols 152, and/or the contextual based content 148 can be located outside of the file 105 using the dynamic links (i.e. content requests 113). It is recognised that the markup symbols 152 could be used to identify the start and end points of each of regions Ri in the content 146, as further described below.

User Device 100

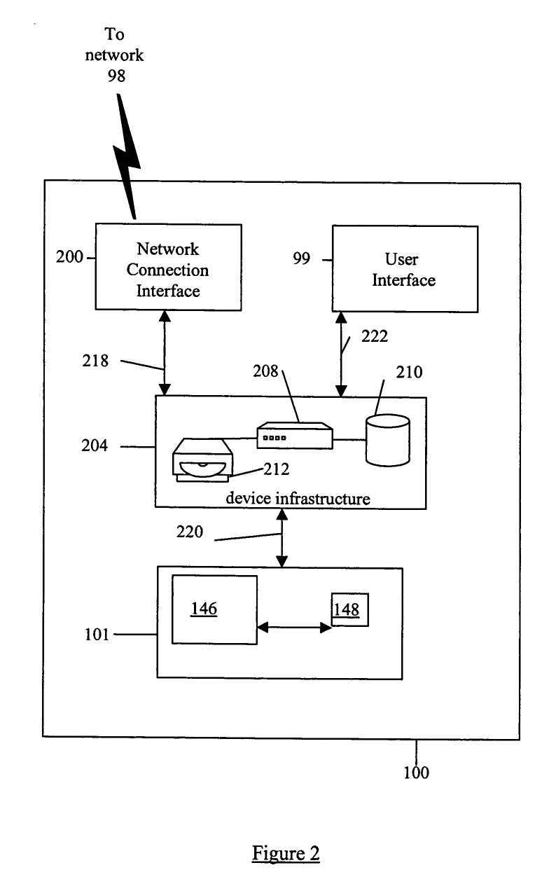

Referring to FIGS. 1 and 2, the devices 100 are devices such as but not limited to mobile devices, desktop computers, PDAs, or dual-mode communication devices. The devices 100 include a network connection interface 200, such as a wireless transceiver or a wired network interface card or a modem, coupled via connection 218 to a device infrastructure 204. The connection interface 200 is connectable during operation of the devices 100 to the network 98, such as to the wireless network by RF links, which enables the devices 100 to communicate with each other and with external systems (such as the servers 107,110) via the network 98 and to coordinate the information requests 109 and processing of received files 105 and the associated contextual based content 148 via a client program such as the browser 101. The browser 101 is an example of an application program executing on the device 100 that provides an interface to look at and interact with all the information available from the content server 107 via the network 98, for example by browsing (navigate through and read) text files online. The Web browser 101 is a client program that uses the Hypertext Transfer Protocol (HTTP) to make requests of Web content servers 107 via the network 98 (e.g. the Internet) on behalf of the browser user.

Referring again to FIG. 2, the devices 100 also have the user interface 99, coupled to the device infrastructure 204 by connection 222, to interact with the user. The user interface 99 includes one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 204. The user interface 99 is employed by the user of the device 100 to coordinate the information requests 109 and display of received files 105, as well as to interact with the contextual based content 148 present on the display and the association instructions 150 used to coordinate the display of the contextual based content 148 in relation to the display of the content 146, further described below.

Referring again to FIG. 2, operation of the device 100 is enabled by the device infrastructure 204. The device infrastructure 204 includes a computer processor 208 and an associated memory module 210. The computer processor 208 manipulates the operation of the network interface 200, the user interface 98 and the browser 101. Further, it is recognized that the device infrastructure 204 can include a computer readable storage medium 212 coupled to the processor 208 for providing instructions to the processor 208. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid state memory card, or RAM provided in the memory module 210. It should be noted that the above listed example computer readable mediums 212 can be used either alone or in combination.

It is recognized that the association instructions 150 can be used to access the contextual based content 148 in a number of ways, such as but not limited to: the contextual based content 148 residing in the file 105 provided to the device 100; the contextual based content 148 resident on the information environment 106 (as provided by the content analyzer environment 104, for example); and the contextual based content 148 resident on the content analyzer environment 104 and provided when requested by the user of the device 100 through interaction with the displayed content 146.

Information Environment 106

Referring again to FIG. 1, the content server 107 of the environment 106 is used to facilitate the delivery of the content 146 over the network 98, as requested in the information request 109 by the device 100. The content server 107 can be represented as a computer program that provides services to other computer programs (e.g. the browser 101) of the devices 100. In the client/server programming model, the content server 107 is a program that awaits and fulfills the requests 109 from the client programs (e.g. browsers 101) for displayable/presentable content 146. The content server 107 functions as a server of responses (e.g. files 105 containing information content 146 and including associated contextual based content 148) that satisfy the requests 109 received from the devices 100, as well as a client through requests 112a,112b for services from the content analyzer module 110 for contextual based content 148 matching the requested content 146 once analyzed. It is recognized that the information environment 106 could also be configured, via suitably assigned modules, for receiving the content request 113 and for forwarding to the content analyzer environment 110 designated for delivering the contextual based content 148 associated with the primary content 146 linked to the content request 113. The information environment 106 can be further configured for receiving the requested contextual based content 148 and for forwarding same to the device 100 in response to the content request 113.

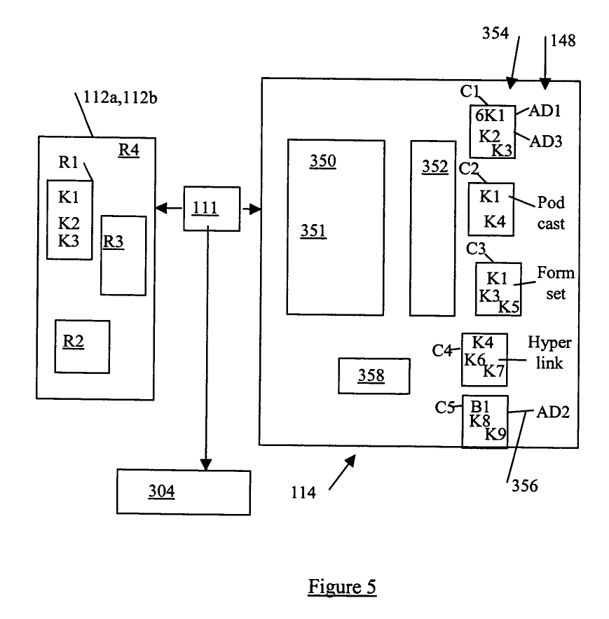

Referring again to FIG. 1, upon receiving the request(s) 109 from the device(s) 100, the content server 107 selects content 146 from an information storage 118 in order to satisfy the request 109, as well as retrieves pertinent contextual based content 148 and association instructions 150 (see FIG. 5) related to the selected content 146. The content server 107 then sends the content 146 and association instructions 150 back to the device 100 as the file 105. It is recognized that at least a portion of the selected content 146 could be dynamically calculated by the content server 107, based on parameters of the request 109. In the case where the contextual based content 148 is not sent back in the file 105 with the content 146 and association instructions 150, the content server 107 facilitates subsequent delivery of the corresponding contextual based content 148 based on user interaction with the content 146, as further described below.

The contextual based content 148 and association instructions 150 pertaining to the selected content 146 can be obtained using a number of different scenarios. In a first example scenario, upon receiving the request 109, the content server 107 selects the pertinent content 146 and forwards this selected content 146 to the file analyzer 110 of the content analyzer environment 104, as content file 112b. The file analyzer 110 in turn uses association rules 114, as further described below, to analyze all identifiable elements of the selected content 146 of the content file 112b

to dynamically determine appropriate contextual based content 148 for linking to the selected content 146 via relevant association instructions 150. The content 146 is also modified in order to display indications on the user interface 99 of the determined key elements K1,K2,K3 (see FIG. 5), present in the identifiable elements of the content 146, which are linked to the contextual based content 148. For example, as further described below, this indication could be a highlighted, underlined, or by other distinguishing visual/audio techniques of the key elements K1,K2,K3 to assist the user of the device 100 in identifng the determined key elements K1,K2,K3 from the rest of the content 146 presented on the user interface 99. Accordingly, the contextual based content 148 is associated with the determined key elements K1,K2,K3, which are chosen from all identifiable elements of the content 146, as further described below.

The file analyzer 110 then sends the appropriate contextual based content 148 and association instructions 150 back to the content server 107 along with the modified content 146, e.g. as the file 112b, which is then forwarded to the device 100 for subsequent processing and display by the browser 101 as file 105. It is recognized that the content file 112b could also contain information about the user (identification information, user profile, user behaviour), which could also be used by the content analyzer 110 (along with the selected content 146) to dynamically determine appropriate contextual based content 148 and association instructions 150, as further described below. It is recognized that the user behaviour can include parameters such as but not limited to: history of access to information of information environment 104 including information type and frequency/timing of access; history of access to information not from presently selected information environment 104; identification details of browser 101 user and/or of device 100; information on user/device obtained from a third party information database (not shown)—example air miles or other reward programs; or a combination thereof. Further, it is recognized that the user behaviour information could be supplied with the content request 113 and/or the information request 109 in order to determine which of the contextual based content 148 is selected/generated to be supplied in response to the requests 109, 113.

In a second example scenario, rather than sending the contextual based content 148 back to the content server 107 in the file 112b as described in the first scenario, only the association instructions 150 and the modified content 146 would be included in the file 105 intended for receipt by the device 100. The associated contextual based content 148 would be stored separately from the file 105 in the storage 118 of the information environment 106, in the storage 119 of the content analyzer environment 104, or a combination thereof. Accordingly, upon activation of the association instructions 150 during display of the modified content 146 from the file 105 on the user interface 99, the related contextual based content 148 would be retrieved from the storage 118,119 (e.g. in response to the content request 113) and then presented on the user interface 99 in the manner defined.

In a third example scenario, prior to receiving the request 109, the content server 107 sends content files 112a (e.g. standard content partitioned into Web pages/files 105 for satisfying anticipated requests 109) obtained from the information storage 118 to the file analyzer 110 of the content analyzer environment 104. The content analyzer 110 in turn uses association rules 114, as further described below, to analyze the selected content 146 of the content files 112a to determine appropriate contextual based content 148 and association instructions 150. The content 146 is also modified in order to display indications on the user interface 99 of the determined key elements K1,K2,K3 (see FIG. 5), present in the content 146, that are linked to the contextual based content 148. The file analyzer 110 then sends the modified content 146, the appropriate contextual based content 148 and the association instructions 150 back to the content server 107, e.g. as updated file(s) 112a, stored subsequently in the information storage 118. Upon receiving the anticipated request 109 from the device 100, the content server 107 retrieves the selected modified content 146 and related contextual based content 148 and association instructions 150 from the information storage 118 and forwards such to the device 100 for display in the browser 101. It is recognised that the contextual based content 148 can be included as part of the file 105 sent to the device 100 or can be stored and accessed separately from this file 105 (e.g. using the content request 113), as described above in reference to scenarios one and two, as desired. It is recognized that operation of the content analyzer 110 on respective content files 112a could be done periodically in order to account for updates/modification to the publisher content 146 stored in the storage 118. It is also recognized that the third scenario could be better suited for situations in which the content 146 and anticipated requests 109 are more of a standardized, static nature and therefore do not need dynamic (i.e. real-time) association of the contents 146,148 as provided by the first scenario.

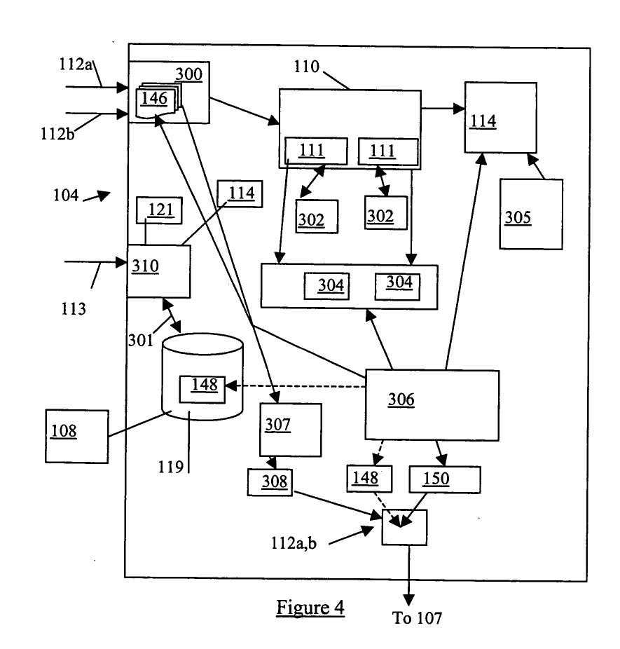

Referring to FIG. 4, in cases where the contextual based content 148 is sent to the device 100 separately from the file 105 (i.e. including the modified content 146 and the association instructions 150), the file analyzer 110 can use an association module 310 to facilitate matching and subsequent sending of the relevant contextual based content 148 in view of the context requests 113 received from the device 100. the association module 310 can also track the usage of a queue 301 for access to particular contextual based content 148 examples/types supplied in response to certain content requests 113, in order to dynamically determine the contents of the contextual based content 148. The module 310 also has access to the association rules 114 in order to determine the dynamic allocation of the contextual based content 148 in response to the content request(s) 113. These context requests 113 are sent to the information environment 106 (or content analyzer environment 104 if configured) as a result of interaction via the user interface 99 with distinguished key elements K1,K2,K3 (see FIG. 5) present in the modified content 146. The context requests 113 contain identifying information for the contextual based content 148 associated with the matching distinguished key elements K1,K2,K3, information such as but not limited to: identification of specific contextual based content 148 (e.g. ID for specific ads); identification for specific types/categories of contextual based content 148 (e.g. ID for ad types/categories); or a combination thereof. In the case of involvement of the information environment 106, the association module 310 can keep track of the device 100 providing the context request 113 and can determine what contextual based content 148 is needed to satisfy each of the context requests 113. The association module 310 determines the identifying information in the context requests 113 and can match the needed contextual based content 148 to the identifying information using a table 121, which can include expected identifying information matched to the needed contextual based content 148. In the case where the association module 120 is located in the information environment 106, the needed contextual based content 148 can be retrieved from the local storage 118 and/or retrieved from the content analyzer environment 104. Once retrieved , the association module 120 can send the retrieved contextual based content 148 back to the requesting device 100 in a supplemental file 105, as received in conjunction with the association module 310 selecting the contextual based content 148 from the queue 310 and/or the storage 119, for example. The supplemental file 105 can include data 154 and markup symbols 152 defining retrieved contextual based content 148, as well as instructions on the method and/or manner of presentation of the contextual based content 148 on the user interface 99.

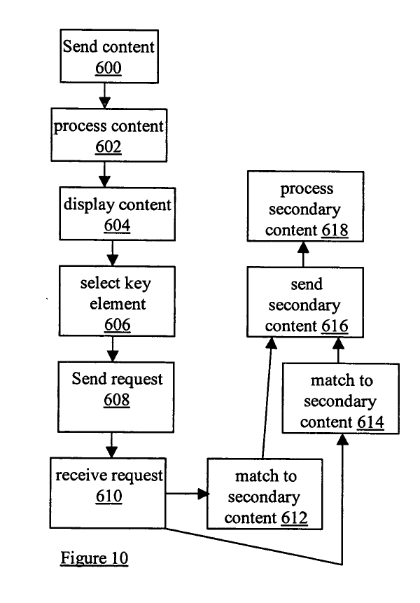

Referring to FIG. 1 and example operation in FIG. 10. For example the file 105, including highlighted keywords (distinguished key elements K1,K2,K3) in a series of paragraphs of a webpage (the modified content 146), is sent 600 to the device 100 in response to the information request 109. The file 105 is then processed 602 and then subsequently displayed 604 on the user interface 99 by the browser 101. The user of the device 100 selects 606 one of the highlighted keywords (e.g. via a mouse-over or other user event) and the scripted hyper link (example of association instructions 150) assigned to the selected keyword facilitates the sending 608 of the corresponding context request(s) 113 to the information server 107 asking for an advertisement (example of contextual based content 148) for display in relation to the selected keyword. The association module 120 receives 610 this context request(s) 113 and either matches 612 the corresponding identifying information to a specific advertisement (or advertisement type/category) for contextual based content 148 available in the local storage 118, or facilitates matching 614 the corresponding identifying information to a specific advertisement (or advertisement type/category) for contextual based content 148 dynamically available through the content analyzer environment 104. In either case, the association module 120 can facilitate the sending 616 by the information server 110, for example, of the needed contextual based content 148 back to the device 100 as the supplemental file 105, in response to the original information request 109 and follow up context request(s) 113. The supplemental file l OS is then processed 618 by the browser 101 and the corresponding contextual based content 148 is presented on the user interface 99 in relation to the modified content 146. It is recognized that the context request 113 can cause more that one supplemental file 105 to be generated and sent to the device 100 (e.g. one context request 113 can cause two or more supplemental files 105 to be sent at different times to the device). Another option is for one context request 113 to cause periodic updates of contextual based information 148 stored in the storage 18 of the information environment 106.

In view of the above, as an example specific to the Web, a Web content server 107 is a computer program that serves requested HTML files 105. For example, the Web browser 101 of the device 100 is a client that requests HTML files from the Web content servers 107. It is understood that the file 105 can be used in many web applications as an HTML (Hypertext Markup Language) file 105, an XML (Extensible Markup Language) file 105, or a combination thereof (other schema defined languages are applicable as well). One example is where XML markup can appear within an HTML structured file 105. The devices 100 can operate as web clients of the web services by using the request messages 109 and response files 105 in the form of message header information and associated data content, for example requesting and receiving selected product pricing and availability information (e.g. content 146) from an on-line merchant (e.g. information environment 106), along with associated ads for related products (e.g. contextual based content 148) that are related to the product pricing and availability information (as defined by the association rules 114). For satisfying the appropriate requests 109, the content servers 107 can communicate with the devices 100 through various protocols (such as but not limited to HTTP and component API) for exposing relevant business logic (methods) to client application programs (e.g. browsers 101) provisioned on the devices 100. The web service provided by the content server 107 can be defined as a software service, which can implemented as an interface expressed using Web Services Description Language (WSDL) registered in Universal Discovery Description and Integration (UDDI), Registry.

Content Analyzer Environment 104

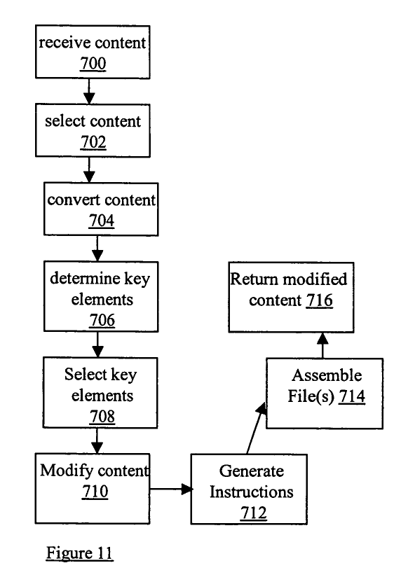

Referring to FIGS. 4 and 11, the content analyzer environment 104 is shown. Requested content files 112a, 112b incoming from the information environment 104 are received 700 by a request queue 300. The content analyzer 110 (or analyzers 110) select 702 content files 112a,112b (e.g. first in first out) from the request queue 300, and convert 704 the files 112a,b into corresponding content model(s) 302 (e.g. Document Object Models (DOM)) that provide systematic and dynamic access to the identifiable elements of the content files 112a, 112b (e.g. to markup symbols 152 and the data content 154). A series of association rules 114 are used to calculate 706 the relevancy of all the identifiable elements in the content 146 represented by the models 302, in order to determine key elements K1, K2, K3 (see FIG. 5), further described below. A context manager 305 is used to administer the definition of the association rules 114, based on input from a number of sources including the information environment 106, administration of the context analyzer environment 104, and suppliers 108 (see FIG. 1) of the contextual based content 148, as desired.

Once the models 302 are processed, a number of best scored elements 304 are determined 708 for a given file 112a,b, representing the determined key elements K1, K2, K3. A file assembler 307 uses the best scored elements 304 to generate 710 a modified content 308, by modifying the content 146 of the received files 112a,b in order to facilitate visual and/or audio distinguishing of the determined key elements K1, K2, K3 with respect to the rest of the content 146 (when presented on the user interface 99). This distinguishing of the determined key elements K1,K2,K3 can be done using techniques such as but not limited to: highlighting; bolding; underlining; changes in font and or colour; audio sounds; animation; use of identification symbols presented adjacent to the key elements 350; outlining; or a combination thereof. It is recognized that the distinguishing of the determined key elements K1,K2,K3 from the rest of the unmodified content 146 is for facilitating recognition by the user of the device 100 for those portions of the modified content 146 to which the contextual based content 148 is associated. For example, when a word or phrase (example of the determined key elements K1,K2,K3) is highlighted (example of the modified content 308) with respect to the rest of the surrounding text (example of the unmodified content 146), a dynamic link (example of the association instructions 150) will cause a pop-up ad (example of the contextual based content 148 ) to be displayed/presented on the user interface 99 along with the surrounding text/images. It is also recognized that the modified content 308 may also contain selected key elements K1,K2,K3 that are not distinguished from the rest of the content 146, as desired.

The environment 104 also has an instruction generator 306 (e.g. a script generator) used to utilize the best scored key elements 304 information generated by content analyzer 110 to build 712 the association instructions 150 (e.g. client-side script (JavaScript)), to facilitate linking of selected contextual based content 148 to the determined key elements K1,K2,K3 of the content 146, and the subsequent display of same. The instruction generator 306 uses the association rules 114 to determine which of the contextual based content 148 in a storage 119, for example, should be selected for linking to the determined key elements K1,K2,K3. The selection of the relevant contextual based content 148 is based on a count of the number of determined key elements K1,K2,K3 in a predefined category 354 (see FIG. 5), further described below. It is recognized that the link could be generic (e.g. linking to any ad of a specific category/type) or specific (e.g. linking to a predefined ad or ads associated with a specified category/type). It is recognized that the type/content of the selected contextual based content 148 can be based on contextual analysis of the text and/or images of the content 146, as performed by the content analyzer 110 and the instruction generator 306.

The file assembler 307 assembles 714 the files 112a,b to contain the association instructions 150 and the modified content 308 (for example including both the distinguished key elements K1,K2,K3 and the rest of the content 146) as the files 112a,b for returning to the content server 107, for example. The file assembler 307 may also include the selected contextual based content 148 in the files 112a,b or store the selected contextual based content 148 in the storage 119 for retrieval through a content queue 301 and/or via the content providers 108.

The association module 310 receives a content request 113 from the content server 107, in response to activation of the association rules 150 (e.g. mouse-over of key element K1,K2,K3 displayed on user interface 99 and/or activation of associated link via the user). The association module 310 can be used in cases where dynamic association of the contextual based content 148 is desired for those key elements K1,K2,K3 displayed on the user interface 99, as further described below.

Content Analyzer 110

Referring to FIG. 4, a dynamic queue 300 receives requested content files 112a,112b (e.g. web pages) intended for analysis by the content analyzer 110. The content analyzer 110 maintains the dynamic queue 300 (e.g. containing content files 112a,112b from multiple environments 106—not shown) and passes resident content files 112a,112b to available worker processes 111 for analysis. The worker processes 111 convert each content file 112a,112b as full-fledged program objects into a content model 302 (e.g. a Document Object Model (DOM)) that provides systematic and dynamic access to the markup symbols 152 and the data content 154 of the content files 112a,112b. Accordingly, the models 302 provide a predefined data structure (i.e. a programming interface specification such as a hierarchical tree structure) for combining objects of the standard set of objects (for example) that are used to represent the content files 112a,112b (e.g. HTML pages and/or XML documents), which provides an interface to the worker processes 111 for subsequent systematic access and manipulation of the markup symbol 152 elements and related meaningful data content 154.

It is recognized that the worker processes 111 could store/cache the models 302 generated for each of the content files 112a,112b for a selected time period, such that subsequent requests for the same content files 112a,112b would simply reuse the existing respective models 302 rather than regenerate same. For example, the status of the content files 112a,112b could be tracked by the worker processes 111 through date and timestamp information. In the case where the information of incoming content files 112a,112b does not match the date and timestamp information associated with the respective models 302, then new models 302 would be generated and the older models 302 would be deleted.

Association Rules 114

Referring to FIGS. 4 and 5, the worker processes 111 use association rules 114 to calculate the relevancy of all identifiable elements in the content 146 of the files 112a,112b to the type/content of the contextual based content 148, based on a contextual analysis of the text and/or images (for example) of the content 146. The worker processes 111 operate as density engines to determine the density of context in particular defined regions Ri of the content 146 in the files 112a,112b, i.e. the worker processes 111 determine the number of identifiable elements in the predefined/specified regions matching at least one or more key elements 350 in a list of key elements 305. It is recognized that definition of the regions Ri can be part of the association rules 114 and/or can be part of the files 12a,b sent from the server 107 to the analyzer engine 110, as desired. The association rules 114 include the list of key elements 350 (e.g. words, images) as a system of contexts, which are used for comparison purposes against any identified elements (e.g. markup symbol 152 elements and related meaningful data content 154) of the content 146 (e.g. including textual and/or graphical/image content). It is recognized that the key elements 350 can also include user identification parameters 351 (e.g. name, country, profession, browsing behaviour and/or user profile, shopping profile, or other user profile data), as described. The user identification parameters 351 could be part of the information requests 109 and/or the content requests 113, as desired. The browsing behaviour of the user can include behaviours such as but not limited to: type of ads interacted with; number of visits to the publisher environment; number of visits to a particular Web page; amount of time spent on a particular Web page, ect. . . . Accordingly, it is recognized that the placement and content of the contextual based content 148 in the content 146 can be dependent upon the browsing behaviour and/or user profile, the resultant contextual analysis of the content 146, or a combination thereof.

In any event, the use of determined key elements 350 from the content 146, in context with their region Ri, and/or the use of user behaviour/identification parameters 351 can facilitate the static and/or dynamic association of selected contextual based content 148 with the content 146. Further, it is recognized that the user behaviour/identification parameters 351 can be included in the categories Ci (see user parameter B1 of category C5 in FIG. 5 as an example), for initial determination of contextual based content 148 for association with the determined key elements 350 of the corresponding category Ci, which are used to generate the association instructions 150. Further, it is also recognized that the user behaviour/identification parameters 351 can be included in the content requests 113. This inclusion can be used to assist in dynamic selection of the content based content 148 for satisfying the request 113. For example, a association module 310 would be used in response to the received content request 113 to either select the appropriate contextual based content 148 dynamically from the queue 301 or to select a particular contextual based content 148 from the storage 119 in view of the association rules 114 specifying the contextual based content 148 selection with respect to the user behaviour/identification parameters 351 present in the content request 113.

The association rules 114 also have a listing of weights 352 (e.g. a percentage weight) to be applied to the key elements 350 to facilitate in the calculation of best scoring and most relevant contexts associated with the key elements 350. Further, the association rules 114 also have a list of categories 354 that contain a predefined grouping of key elements 305 (one or more key elements 350) and/or a predetermined threshold of key elements 350. For example, category C1 contains any number of predefined key elements K2 and K3 and at least six of predefined key element K1. The association rules 114 also have a listing of contextual based content 148 (e.g. particular ads AD1,AD2,AD3, podcast, form-set, hyperlink, type, etc.) that are link associated 356 with each category 354. For example, the ad AD1 is linked to category C1 in the event that predefined key elements K1,K2,K3 are present (i.e. recognized from all the identifiable key elements of the content 146) in the selected region R1 of the content 146, while the ad AD3 is linked to the category C1 in the event that predefined key elements K2,K3 and six or more of predefined key elements K1 are present (i.e. recognized from all the identifiable key elements of the content 146) in the selected region R1. Accordingly, each of the contextual based content 148 (e.g. per ad) comes with a list of predefined key elements 350, for a specified category Ci, that is relevant as context, such that lack of identification of the respective list of the key elements 350 for a particular contextual based content 148 would result in non-use in the file 105 (i.e. not configured for display in the user interface 99).

The association rules 114 can also have configuration data 358, which can be used to specify the max/min number of ads (or other contextual based content 148) per page/file 105, the display format and/or behaviour of the contextual based content 148, the types of the contextual based content 148 (e.g family versus R rated), configuration of the categories Ci and/or category types, and how to structure/format the contextual based content 148 based on the response of the user. The configuration data 358 can include the display timing of the advertisement information (e.g. click-on, mouse-over events) and the positioning of the advertisement information (contextual based content 148) with respect to the content 146 on the user interface 99. The association rules 114 are administered by a context manager 305 that facilitates configuring of contexts, key elements 350, weights 352, configuration data 358, links 356 (for use in generating the association instructions 150), and calculations for resultant scores based on category 354 definitions. The association rules 114 supported by the Context Manager 305 is used for page/file 112a,b-to-context analysis and contextual based content 148 configuration. It is recognized that the association module 310 has asscess to the rules 114 for use in determineing the dynamic selection of the contextual based content 148 from the queue 301, from the storage 119, or dynamically generated, as desired.

Referring to FIG. 1, it is recognized that the association rules 114 can also be used to select contextual based content 148 from third party providers 107, based on the third party scoring systems 111 of their own contextual based content 148 and associated key element lists.

For example, the ad inventory (contextual based content 148) of the information environment 106 has attached to it weighting values 352 (see FIG. 5), which can be the deciding values when two ads would ‘tie’ for placement. This value is based on the advertisers value placed on the ads context. When evaluating information environment 106 ads against other systems 107 ads, the analyzer module 110 would translate the weighting value 352 of the other systems 107 into a equivalent information environment 106 weighting value 352 using a data brokerage layer 115. For example, the date brokerage layer 115 has been programmed to recognize Goggle ad values as “Goggle weight of 1 equals information environment 106 weight of 0.5, therefore when comparing an information environment 106 ad of weight 2 and Goggle ad of Weight 5, the Goggle ad would be placed. This is as compared to an information environment 106 weight of 2 versus a Goggle weight of 4, which would equal a tie, in which case the information environment 106 ad would be placed.

Accordingly, the content analyzer module 110 and/or the association module 120 could use the contextual based content 148 from their own local contextual based content 148 inventory in storage 119, as well as use the data brokerage layer 115 to evaluate remote material from other partnered systems 107 for use as the contextual based content 148 sent to the device 100. The modules 110,120 would first check local inventory for contextual based content 148 and then decide to send as a search term the particular key element 350, or elements 350 (related to the local contextual based content 148 in the local inventory), as a content request 117 to the remote system 107. The remote system 107 would in turn use the supplied key element(s) 350 in the content request 117 to search through their own inventory of material suitable for use as secondary content and the return via a response any material matching the supplied key element(s) used as search terms. the module 110,120,310 would then use the data brokerage layer 115 to evaluate via value/weighting mappings whether the returned material has the same or greater value (e.g. weighting) than the corresponding contextual based content 148. The content request 117 represents a search query containing the key element(s) 350 that is sent for use in searching by the system(s) 107.

Worker Processes 111

Once converted, systematic access by the worker processes 111, via programs and/or scripts, of the content 146 represented by the models 302 is done by parsing the markup symbols 152 (e.g. HTML, XML), in order to recognize all identifiable elements in the content 146. In order to determined valid (e.g. W3C compliant), markup symbol 152 elements identify meaningful data content 154 (e.g. content 146 including textual and/or graphical content), in view of those identifiable elements matching the key elements 350 in the key element 350 list (of the association rules 114). It is recognized that the worker processes 111 could also rely upon the markup symbols 152 themselves in order to ascertain whether the data content 154 is meaningful (e.g. the markup symbols 152 themselves could describe via key words the contents of an image). Further, it is recognized that the worker processes 111 would ignore/disregard any data associated with markup symbols 152 related to navigation, file 112a,112b identification and other non-content 146 (content other than text/images) included in the content files 112a,112b. Accordingly, it is recognized that not all of the content 146 would be deemed as part of the identifiable elements. Further, it is recognized that specific regions Ri of the content 146 could be ignored by the worker processes 11 in determination of the key elements 350, e.g. certain specified pages/paragraphs/image types of the content 146 would be defined as exempt from association with the contextual based content 148. One way to identify these exempt regions could be through the use of the markup symbols 152, some of which would be defined as indicating the exempt region(s) Ri.

The worker processes 111 use the association rules 114 containing the list of key elements 350 (e.g. words, images) as a system of contexts, in order to do a comparison of the determined valid markup symbol 152 elements and related meaningful data content 154 against this system of contexts. Any determined markup symbol 152 elements and/or related meaningful data content 154 matching this system of contexts is stored as best scored elements 304 for a given file 112a,112b. The worker processes 111 also associate the best scored elements 304 for respective regions R1,R2,R3,R4 of the file 112a,112b, on a region by region basis, in order to associate a selected contextual based content 148 for a particular region R1,R2,R3,R4 that match a predefined category 354. The regions R1,R2,R3,R4 can represent portions of the publisher content 146 such as but not limited to: paragraphs of text in an article; the entire article; a grouping of paragraphs; a caption or title; an image or group of images; and the entire contents of the file 112a,112b. For example, referring to FIG. 5, key elements K1,K2,K3 were determined from the publisher content 146 to be related to paragraph R1, which in turn match category C1 that has two ads AD1 and AD3 associated therewith.

Accordingly, as a result of this comparison process, so-called Page Cache objects are generated and stored into Page Cache tables as best scored elements 304. The Page Cache objects represent best scored key elements 304 and best scored contexts for a given file 112a,112b.

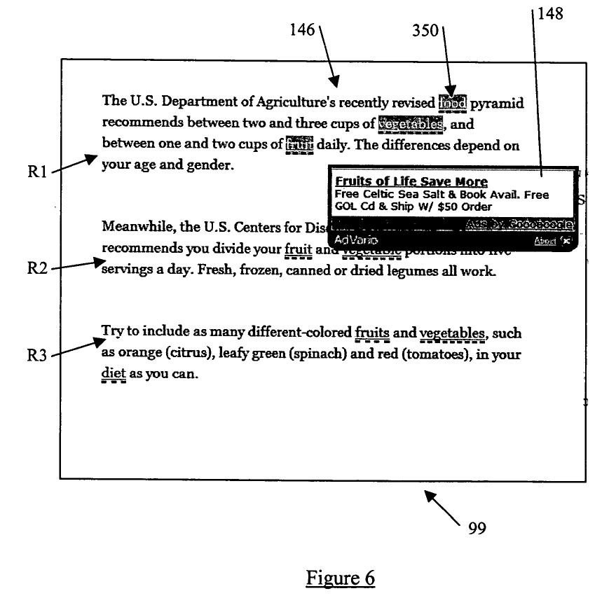

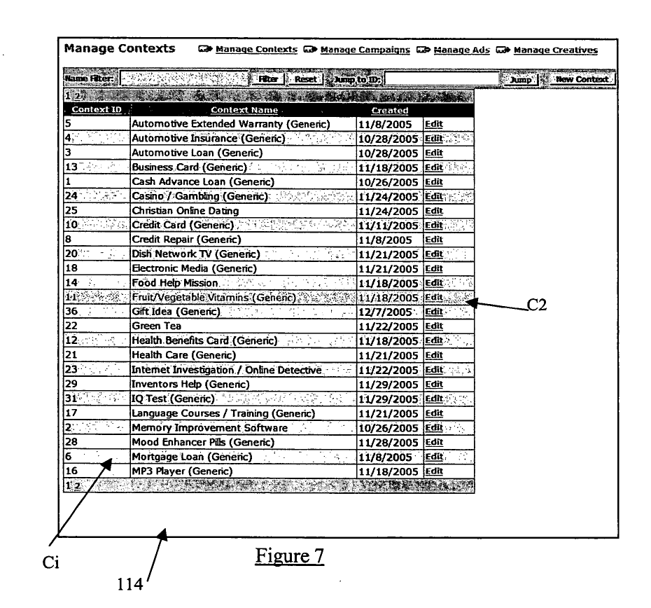

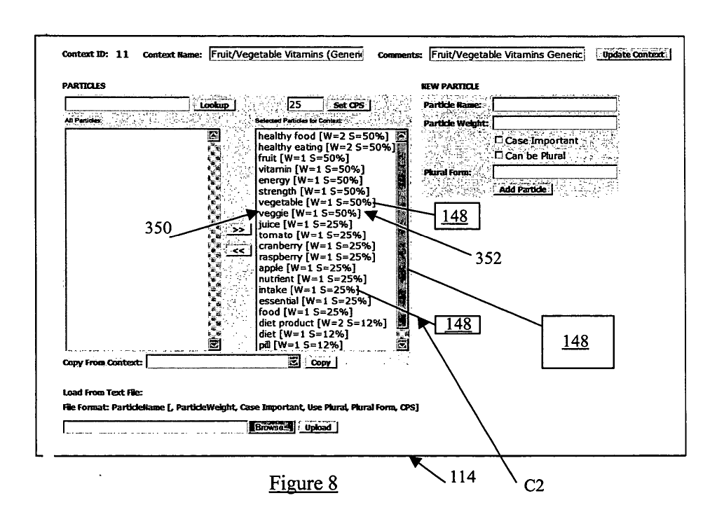

Referring to FIG. 6, shown is an example user interface 99 displaying the content 146 and an associated contextual based content 148. The contextual based content 148 is displayed as associated with the keyword 350 “vegetable” in the second paragraph (defined as region R2). The display of the contextual based content 148 is a result of the keyword 350 “vegetable” being moused over, thus resulting in a fruit ad 148 related in context to other keywords 350 in the region R2 (i.e. “fruit”), as defined in the category C2 (see FIGS. 7 and 8). Referring to FIG. 7, shown is an example portion of the association rules 114, having a list of defined categories Ci, in particular category C2 of “fruit/vegetable vitamins” associated with the contextual based content 148 of FIG. 6. Referring to FIG. 8, shown is the definitions of the category C2, including all weights 352 associated with the included key elements 350. In particular, the keywords 350 “fruit” and “vegetable” are part of category C2. Accordingly, the contextual based content 148 can be associated with individual key element(s) 350 of the category C2, or the category C2 as a whole (i.e. the same contextual based content 148 will be used for any of the included key elements 350).

Accordingly, in view of FIGS. 5,6,7,8, categories Ci are defined and contextual based content 148 are attached to the categories Ci. Further, categories Ci start at the top level and can be termed ‘generic’. They can be as broad or as narrow as the advertiser (entity 108) or broker (environment 106) wishes them to be. Further, within categories Ci, an advertiser can define subcategories Ci, and assign weights 352 to those sub categories Ci. The granularity level can go as deep or as shallow as the advertiser supplier/advertiser broker wishes. These weights 352 are also used to compare contextual based content 148 from other systems (external sources 107 for contextual based content 148—see FIG. 1) against contextual based content 148 associated with the categories Ci defined in the association rules 114. For example, this method allows advertisers to specify levels of contextual granularity from the simple to the complex and attach ads, ad campaigns and weights to each.

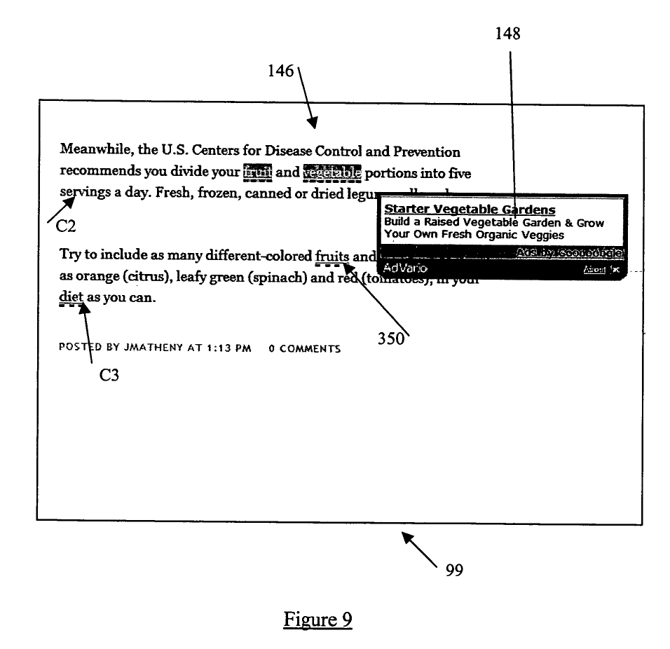

Referring to FIG. 9, shown is the same content 146 of FIG. 6, but with a different contextual based content 148 attached to the same keyword 350 of “vegetable” (obscured by placement of the contextual based content 148), thus demonstrating the dynamic nature of association of the contextual based content 148 with respect to the same key element 350 for different sessions and/or activation of the association instructions 150 pertaining to the same key element 350 at different times in the same session of the browser 101 with the information environment 106. It is recognized that the FIG. 9 is also an example of the use of different contents gathered from a similar grouping of identified key elements 350, but not exact groupings, thus resulting in a different category Ci being assigned to the different paragraphs, which results in different ads being associated to the different paragraphs.

Accordingly, intext ads do not use precious screen real estate and may also not be perceived as interruption advertising, therefore leaving publishers with more room for content, and yielding more qualified leads due to the “opt-in” nature of the ads. The system can be configured such that the ad may not appear until the user interacts with the distinguished keyword 350 (e.g. mouse-over or click-on user events).

Instruction Generator 306

Referring again to FIG. 4, the content analyzer environment 104 also has an instruction generator 306 that utilizes the best scored key elements 304 information generated by content analyzer 110 to build the association instructions 150 (e.g. client-side script (JavaScript)) to facilitate the embedding in the content 146 of the contextual based content 148 and subsequent display of same. The instruction generator 306 can also be responsible for contextual based content 148 matching based on the score of the identified key elements 350 for each region Ri and optional rotation logic such that users may see different contextual based content 148 on subsequent page visits (e.g. using user and/or browser behaviour key elements 350). Accordingly, the instruction generator 306 can be responsible for configuring the contextual based content 148 based on the analysis of the content analyzer 110 as well as for generating the association instructions 150, all for inclusion in the file 105. The instruction generator 306 can generate the resultant processed files 112a,112b for sending back to the content server 107 of the environment 106.

The following is an example script stored with the content 146, which is used to invoke sending of the content 146 to the content analyzer environment 104 in response to selection of the content 146 by the browser 101 from the information environment 106.

<SCRIPT language=“JavaScript”
src=“http://v21.advario.com/avgen/launcher.aspx?pubid=41&subid=0”></SCRIPT>

The above example script is present in the content 146 (e.g. at the top of the content 146 data) when first accessed by the device 100 from the information environment 106. the script can be used to facilitate or otherwise automate the sending of the content 146 (via the information request 109) to the content analyzer environment 104 for processing, i.e. identification of the key element(s) 350 in view of the list of key elements 305 purchased from the content analyzer environment 104 by the information environment 106, highlighting or otherwise distinguishing the identified key elements 350, and sending the modified content 308 back to the information environment 106 for subsequent sending and presentation on the user interface 99 of the device 100.

It is recognized that the sequence of instructions 150 can be a script based on ECMAScript, ECMA-262, which is a standard script language that is used in Web pages to affect how the Web pages look/behave for the user of the device 100. For example, JScript is an implementation of the ECMAScript standard. ECMAScript is object-oriented programming language and is a core language to which can be added the objects of any specific domain or context such as the idea of a “document.” (for example, the World Wide Web Consortium's Document Object Model). ECMAScript together with the Document Object Model corresponds closely to the current implementations of JavaScript and JScript. It is recognized that in a class-based object-oriented programming language, in general, state is carried by instances, methods are carried by classes, and inheritance is only of structure and behavior. In ECMAScript, the state and methods are carried by objects, and structure, behavior, and state are all inherited. Example functions of the instructions 150 may be to assign values to data, manipulate screens on the browser 101, or to communicate with the content analysis environment 104 for associating “ads” with the content 146. Some other examples of script languages for the instructions 150 are languages such as but not limited to Perl, Rexx, VBScript, JavaScript, and Tcl/Tk. The scripting languages, in general, are instructional languages that are used to manipulate, customize, and automate the respective processing of the file 105 content by the computing environments 100,104,106.

It is recognized that the structured definition language of the file 105 can be defined as a series of metadata records, which consist of a number of pre-defined elements representing specific attributes of a resource such that each element can have one or more values. Each metadata schema typically has defined characteristics such as but not limited to; a limited number of elements, a name of each element, and a meaning for each element. Example metadata schemas include such as but not limited to Dublin Core (DC), Anglo-American Cataloging Rules (AACR2), Government Information Locator Service (GILS), Encoded Archives Description (EAD), IMS Global Learning Consortium (IMS), and Australian Government Locator Service (AGLS). Encoding syntax allows the metadata of the file 105 to be processed by the respective computing environments 100,104,106 (see FIG. 1), and encoding schemes include such as but not limited to XML, HTML, XHTML, XSML, RDF, Machine Readable Cataloging (MARC), and Multipurpose Internet Mail Extensions (MIME). It is recognized that the encoding schemas are used to facilitate the display of “ads” in the browser 101 of the user device 100.

The embodiments of the invention in which an exclusive property or privilege is claimed are defined as the follows:

1. A system for assigning secondary content for presentation on a user interface of a device in association with primary content, the system comprising:
a storage for receiving the primary content including a plurality of identifiable elements for analysis as candidates for at least one key element to associate with the secondary content, the plurality of identifiable elements distributed in a number of defined regions of the primary content;
a content analyzer module configured for accessing the primary content and for performing a contextual analysis of the plurality of identifiable elements, the analysis including for each of the number of defined regions determining in the plurality of identifiable elements those said key elements matching element entries in at least one key element list, the analysis further including determining a density of the matched key elements from a specified region of the number of defined regions;
a threshold module for determining the density exceeds a predefined density threshold for a category including a predefined list of category elements, at least some of matched key elements being included in the list of category elements, the category linked to the secondary content; and
an instruction module configured for generating an association instruction for linking the secondary content to at least one of the matched key elements associated with the category;
wherein the secondary content is made available to the device for presentation on the user interface in relation to the primary content through use of the association instruction.

2. The system of claim 1 further comprising a file assembly module configured for assembling a file to contain the primary content and the association instruction coupled to the at least one of the matched key elements of the primary content.

3. The system of claim 2, wherein the file assembly module is further configured to assemble the file to contain the secondary content.

4. The system of claim 2, wherein the file assembly module is further configured for generating a modified primary content including a modified one of the at least one of the matched key elements distinguishable from the plurality of identifiable elements of the primary content.

5. The system of claim 4, wherein the modified one is distinguishable using a distinguishing technique selected from the group comprising: visual and audio.

6. The system of claim 5, wherein the visual technique is selected from the group comprising: highlighted; colour change; underlined; bolded; font style change; shading; animation; and an identification symbol for positioning adjacent to the at least one of the matched key elements.

7. The system of claim 2, wherein the file includes the matched key elements of the primary content configured for presentation on the user interface.

8. The system of claim 7, wherein the primary content of the file represents a desired exchange of data between an information source and the device.

9. The system of claim 7, wherein the file is selected from the group comprising: a message; a document; and at least one page of data.

10. The system of claim 7, wherein the primary content is selected from the group comprising: published material available over a network connected to the device and data generated by a remote process in response to processing of a transaction with respect to the device.

11. The system of claim 7, wherein the primary content is schema defined content including mark up symbols defining data and data for presentation on the user interface.

12. The system of claim 2 further comprising the secondary content being schema defined content including mark up symbols defining data and data for presentation on the user interface.

13. The system of claim 12, wherein the secondary content is selected from the group comprising: a popup window containing presentation data; a flash video; a text box containing text data; and an audio file.

14. The system of claim 12, wherein the secondary content is selected from the group comprising: a banner advertisement; a text link advertisement; a flash advertisement; a hyperlink to the secondary content stored remotely from the device over a network.

15. The system of claim 12, wherein the secondary content is selected from the group comprising: data configured for facilitating a transaction with respect to the device; and an interactive form set.

16. The system of claim 12, wherein the secondary content is selected from the group comprising: on-line publishing content distributed via a URL.

17. The system of claim 12, wherein the secondary content is selected from the group comprising: podcasting data.

18. The system of claim 2, wherein the key elements of the primary content are selected from the group comprising: text; a word; a phrase; an image; and an identifiable location in the primary content.

19. The system of claim 1, wherein the specified region is selected from the group comprising: a portion of text; a paragraph; a section of a page of data; an image; a group of images; and a portion of a data stream.

20. The system of claim 1, wherein the association instruction is configured for facilitating access and presentment of the secondary content on the user interface in response to a user event.

21. The system of claim 20, wherein the association instruction comprises scripted instructions for accessing the secondary content.

22. The system of claim 20, wherein the association instruction is configured to generate a content request for facilitating presentation of the secondary content on the user interface.

23. The system of claim 22 further comprising an association module for receiving over a network the content request originating from the device.

24. The system of claim 23, wherein the association module is further configured for dynamically selecting the secondary content from a plurality of secondary content based on contents of the content request.

25. The system of claim 24 further comprising a secondary content queue containing the plurality of secondary content.

26. The system of claim 23 further comprising the association module configured for dynamically generating the secondary content based on information contained in the content request.

27. The system of claim 1 further comprising association rules for use by the content analyzer module in facilitating determination of said key elements from the plurality of identifiable elements.

28. The system of claim 27, wherein the association rules are configured to include the element entries of the key element list.

29. The system of claim 28, wherein the element entries include entries selected from the group comprising: user identification information and device identification information.

30. The system of claim 28, wherein the element entries include user behaviour entries selected from the group comprising: history of access to the primary content; history of access to other information related to the primary content; and access frequency to an information source of the primary content.

31. The system of claim 30, wherein the user behaviour entries are part of the predefined list of category elements.

32. The system of claim 31, wherein the key element list is the predefined list of category elements.

33. The system of claim 22 further comprising an association module to facilitate matching of the secondary content in view of the content request.

34. The system of claim 33 further comprising association rules for use by the association module in facilitating determination of the secondary content based on the contents of the content request.

35. The system of claim 34, wherein the association rules are configured to include the element entries of the key element list.

36. The system of claim 35, wherein the element entries include entries selected from the group comprising: user identification information and device identification information.

37. The system of claim 35, wherein the element entries include user behaviour entries selected from the group comprising: history of access to the primary content; history of access to other information related to the primary content; and access frequency to an information source of the primary content.

38. The system of claim 37, wherein the user behaviour entries are part of the predefined list of category elements.

39. The system of claim 33, wherein the association module is further configured to select the secondary content from a content queue based on the contents of the content request.

40. The system of claim 33, wherein the data of the secondary content is dynamically generated based on the contents of the content request.

41. A method for assigning secondary content for presentation on a user interface of a device in association with primary content, the method comprising the steps of:
receiving the primary content including a plurality of identifiable elements for analysis as candidates for at least one key element to associate with the secondary content, the plurality of identifiable elements distributed in a number of defined regions of the primary content;
accessing the primary content and for performing a contextual analysis of the plurality of identifiable elements, the analysis including for each of the number of defined regions determining in the plurality of identifiable elements those said key elements matching element entries in at least one key element list;
determining a density of the matched key elements from a specified region of the number of defined regions;
determining the density exceeds a predefined density threshold for a category including a predefined list of category elements, at least some of matched key elements being included in the list of category elements, the category linked to the secondary content; and
generating an association instruction for linking the secondary content to at least one of the matched key elements associated with the category;
wherein the secondary content is made available to the device for presentation on the user interface in relation to the primary content through use of the association instruction.
